(19) United States
(12) Patent Application Publication
(10) Pub. No.: US 2005/0013423 A1
(43) Pub. Date: Jan. 20, 2005

(54) Telecommunication method and apparatus with provisions to exceed usage limit

(76) Inventors: Carol P. Eversen, Long Valley, NJ (US); Donald A. Klein, Somerset, NJ (US)

Correspondence Address: AT&T CORP., P.O. BOX 4110, MIDDLETOWN, NJ, 07748, US

(21) Appl. No.: 10/886,988

(22) Filed: Jul. 8, 2004

Related U.S. Application Data
(60) Provisional application No. 60/488,550, filed on Jul. 18, 2003.

(51) Int. Cl. H04M 15/00

(52) U.S. Cl. 379/114.17; 379/114.01

(57) ABSTRACT

Disclosed is a telecommunication system, method and database for use in providing telecommunication services in connection with a usage limited account. Upon receipt of a request to provide telecommunication services (e.g., to set up a wireless telephone call), it is determined whether the account associated with the service has reached or exceeded a usage limit on the account. If the usage limit has been reached or exceeded, the service may still be provided if the service request satisfies certain predefined service criteria. The predefined service criteria may be configured by the account subscriber, thereby providing greater flexibility in setting up telecommunication services.

This application claims the benefit of U.S. Provisional Application No. 60/488,550, filed Jul. 18, 2003, which is incorporated herein by reference.

### BACKGROUND OF THE INVENTION

The present invention relates generally to providing telecommunication services. More particularly, the present invention relates to providing telecommunication services when predetermined usage limits have been exceeded.

Historically, telecommunication services have been billed on what is essentially a credit basis—unlimited usage is given to the customer and payment is made periodically (e.g., monthly) for the services used during the prior time period. Users of the services (also called subscribers) are generally associated with an account. When telecommunication services are provided to the subscriber, the charge for the services are accrued to the subscriber's account. Often, accounts are associated with specific subscription identifiers, such as a telephone number. At the end of any given time period, the subscriber associated with a particular account is billed for the services provided during the past period.

Despite the fact that such services have withstood the test of time, there are a number of disadvantages associated with billing for services in this manner. Since the service is basically a credit-based service, those with very poor credit may not be able to obtain such services. Additionally, the service is not anonymous—the customer must be identified and usage may be tracked, for example, under appropriate judicial authorization. Finally, usage is not inherently limited to the customer primarily associated with the account. Other household members, for example, may use the service, incurring significant costs that must be paid by the customer primarily associated with the account, rather than by the actual user.

In response to some of the deficiencies of the above described billing methods, prepaid services have gained in popularity. In general, prepaid services involve the prepayment of a given amount of money and, in return, receipt of a prepaid identification number. Whenever calls are made, usage costs are decremented against the prepaid amount. While the user must disclose the prepaid identification number before obtaining such services, personal identification is not necessary. Furthermore, when the prepaid amount is depleted, service is terminated and no further costs can be incurred. In this way, the customer who pays for the prepaid services can control the maximum expenditure by limiting the amount of money that is prepaid.

In one implementation of prepaid wireless services, a wireless phone can be used in conjunction with a standard prepaid card. In this implementation, the wireless phone is used in the same way that any phone is used in conjunction with a prepaid card. A special number is called and the user is prompted to input the prepaid card number. If there is a balance remaining, the user is prompted to input the called number and the call is completed. The prepaid balance is monitored and the call is terminated when the prepaid amount is depleted.

In a second implementation of prepaid wireless services, the wireless phone number is dedicated to pre-paid services. This second implementation of prepaid wireless phone service does not require the dialing of a special number or inputting of a prepaid card number. Rather, when a call is made the network recognizes the calling wireless phone number as one that is associated with a prepaid service. The network then automatically checks the current balance and decrements for usage. When the prepaid balance is depleted, a current call may be terminate, and future calls will not be allowed until the prepaid balance is restored.

Despite the popularity of prepaid services, there remain certain disadvantages in the current implementations. One such disadvantage is that when the prepaid amount is depleted, the phone can no longer be used, except, perhaps, for certain government-mandated emergency calls (e.g., 911). One solution to this problem is disclosed in U.S. Pat. No. 6,463,139. That patent discloses the use of an overflow indicator which, in certain modes of operation, permits calls to be made even if call charges exceed the subscriber's prepaid balance. While the technique disclosed in this patent provides certain advantages, it remains somewhat inflexible.

### BRIEF SUMMARY OF THE INVENTION

The present invention provides an improved technique for providing telecommunication services associated with a prepaid or other usage limited type of account. In accordance with the invention, telecommunication services may be provided to a device associated with an account which has exceeded a usage limit if the request for services satisfies predefined service criteria. The predefined service criteria may be defined by the account subscriber, thus providing greater flexibility to the subscriber. In one advantageous embodiment, the service may be wireless telephone service which is associated with a usage limited account. Using the present invention, a parent can be comfortable giving the wireless telephone to a teenage child knowing that the telephone has a maximum cost associated with its use. At the same time, the parent may set up predefined criteria such that even if the usage limit of the phone is reached or exceeded, the telephone may still be used to make and receive calls to and from the parent's telephone(s). This provides the benefit of a known maximum cost, but also provides the additional advantage that the telephone is still usable for certain subscriber defined criteria.

In accordance with one embodiment of the invention, the request for telecommunication services is a request to establish an outgoing telephone call from the subscriber device to a called device associated with a called telephone number. In this embodiment, the predefined service criteria requires that the called telephone number matches at least one predefined telephone number associated with the subscriber's account. Similarly, the request for telecommunication services may be a request to establish an incoming telephone call to the subscriber device from a calling device associated with a calling telephone number. In this situation, the predefined service criteria requires that the calling telephone number matches at least one predefined telephone number associated with the subscriber's account.

In another embodiment, the request for telecommunication services is a request to send a data message from the subscriber device to a destination device associated with a destination address. In this embodiment, the predefined service criteria requires that the destination address matches at least one predefined destination address associated with the subscriber's account.

In yet another embodiment, the request for telecommunication services is a request to download data to the subscriber device. In this embodiment, the predefined service criteria requires that the data matches at least one predefined class of data associated with the subscriber's account.

The predefined service criteria may be defined by the subscriber and may encompass any conditions satisfactory to the subscriber. This provides for great flexibility in the provisioning of telecommunication services. In various embodiments, the subscriber may directly update an associated database record in order to effect changes to the predefined service criteria. The data structure of the database record is one embodiment of the present invention.

Of course, various combinations of the above embodiments, as well as other embodiments are possible in accordance with the present invention.

These and other advantages of the invention will be apparent to those of ordinary skill in the art by reference to the following detailed description and the accompanying drawings.

### BRIEF DESCRIPTION OF THE DRAWINGS

FIG. 1 shows a communication network 100 within which the present invention may be implemented;

FIG. 2 is a flowchart showing the steps performed in accordance with one embodiment of the invention; and

FIG. 3 shows an exemplary database record in accordance with one embodiment of the invention.

### DETAILED DESCRIPTION

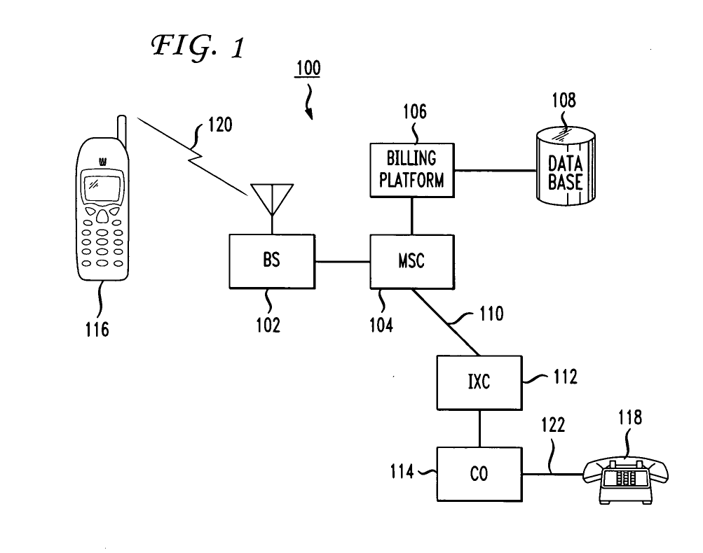

FIG. 1 shows a communication network 100 within which the present invention may be implemented. Network 100 comprises a base station (BS) 102 connected to a mobile switching center (MSC) 104. The MSC 104 is further connected to a billing platform 106. The billing platform is further connected to a database (DB) 108. The MSC 104 connects to the public switched telephone network (PSTN) via communication link 124 and interexchange carrier switch (IXC) 112 and central office switch (CO) 114. As is well known, communication networks, such as network 100, generally contain a plurality of base stations, each of which communicates with mobile stations within the geographic serving area (cell) of the base station. Each base station is connected to, and controlled by, an MSC. Depending on the architecture, a communication network may have more than one MSC, with each MSC controlling a plurality of BSs. The architecture of a communication network, such as network 100, is well known in the art and will not be described in further detail herein.

For ease of illustration, FIG. 1 shows one MSC 104 connected to one BS 102. As shown in FIG. 1, a wireless telephone 116 is communicating with network 100 via BS 102 via a wireless communication channel 120. Landline telephone 118 is communicating with network 100 via CO 114 via line (e.g., copper pair) 122.

The present invention is advantageous in a telecommunication system in which a subscriber's usage is limited in some way. There are various ways in which a subscriber's usage may be limited. One type of limited usage plan is prepaid service in which a subscriber prepays for telecommunication services and the services received by the subscriber are limited based on the balance of the prepaid account. For example, a subscriber could prepay an amount (e.g. $40) to a wireless service provider, and then the subscriber could obtain wireless services having up to a $40 value. In this type of plan, the usage is limited based on the balance remaining in the subscriber's prepaid account.

Another type of limited usage plan may be a monthly usage limit. For example, a subscription plan may be set up to allow $40 dollars worth of usage each month. This type of plan is similar to the prepaid plan discussed above, except that the balance in the account is reset to $40 at the beginning of each month.

These types of limited usage plans are often used in connection with the provisioning of wireless telecommunication services. In this way, a wireless phone can be given, for example, to any member of the household, such as a teenage child, without being concerned that large costs will be accrued. Rather, in accordance with the parent-customer's instructions to the service provider, service will be terminated when the usage limit has been reached. While this type of account provides certain benefits, e.g. a maximum cost to the subscriber, it also has some disadvantages. For example, a parent-customer, may be concerned that the child will use up the monthly amount and the child will then be unable to call the parent.

The present invention solves the disadvantage of the prior art by allowing the subscriber (e.g., parent) to define certain types of calls which will be allowed, even if the usage limit has been reached or exceeded. (As used herein, the term exceeded, when used to describe a usage limit, means reached or exceeded). For example, and based on the above parent/child example, it is likely that a parent may allow calls between the child's wireless phone and the parent's home landline telephone, regardless of whether the wireless telephone's usage limited has been exceeded.

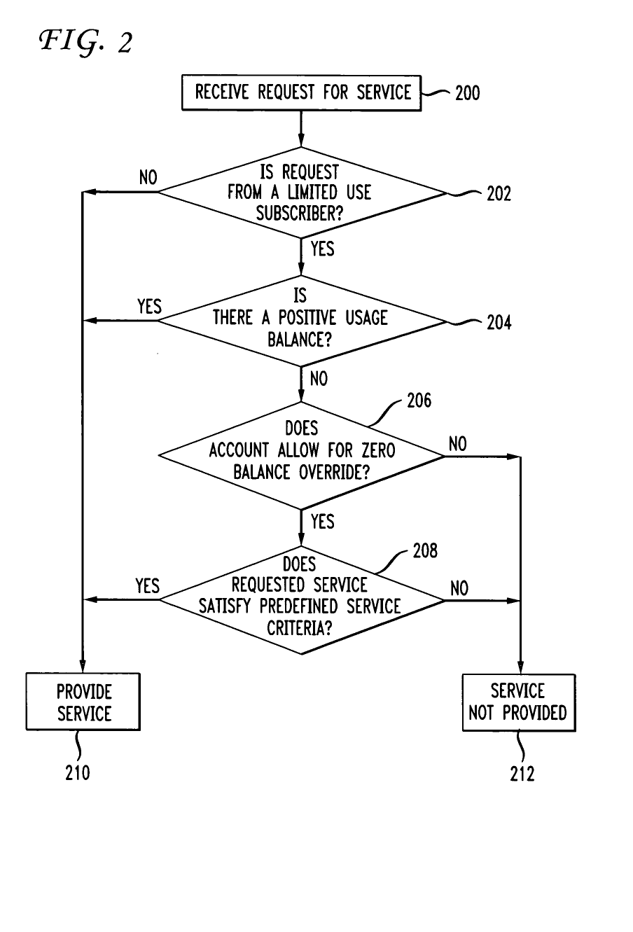

The steps to be performed in accordance with one embodiment of the invention will be described generally in connection with the flowchart of FIG. 2. After this general description, several particular exemplary embodiments will be described. First, in step 200, the telecommunication system receives a request for service. This request may be any type of telecommunication service, for example a request from a telephone to establish a call with a dialed telephone number. In step 202 it is determined whether the request is from a limited use subscriber. If not, then service is provide in step 210 in a conventional manner. If the request is from a limited use subscriber, then in step 204 it is determined whether there is a positive usage balance. If there is a positive usage balance, then service is provided in step 210 in a conventional manner. If there is not a positive usage balance, then it is determined in step 206 whether this subscriber's account allows for a zero balance override. If not, then service is not provided (step 212). If this subscriber's account allows for a zero balance override then in step 208 it is determined whether the requested service satisfies a predefined service criteria. The predefined service criteria may be any subscriber defined criteria which can be used to determine whether service should be provided notwithstanding that this account has reached or exceeded its usage limit. If the service request satisfies the predetermined service criteria, then service is provided in step 210. If the service request does not satisfy the predetermined service criteria, then service is not provided in step 212.

A particular example will now be described in conjunction with FIGS. 1-3. For this particular example, assume that wireless telephone 116 has a telephone number of 123-456-7890 and is associated with a limited use account. Also assume that wireless telephone 116 dials number 333-111-9999, which is the telephone number of another wireless telephone (not shown). First, when the wireless telephone 116 dials the telephone number, the telephone 116 communicates with BS 102 via channel 120. BS 102 transmits the call request to MSC 104. Thus, at step 200 (FIG. 2) the MSC 104 receives a request for establishment of a telephone call from wireless telephone 116 to the telephone associated with the dialed number.

In step 202 the MSC 104 determines whether telephone 116 is associated with a limited use account. In one embodiment, this is accomplished by forwarding the call information to a billing platform 106. The billing platform may be, for example, a programmable computer containing appropriate hardware and software in order to perform the functions described herein. Such platforms, also sometimes referred to as adjuncts, are well known in the art of telecommunications. It is also noted here that the functions described herein may be performed directly by the MSC 104 (which may also include appropriate hardware and software for performing the functions described herein) rather than by the billing platform 106. One skilled in the art would recognize that there are various configurations possible for carrying out the inventive steps described herein. Many of the functions described herein may be performed by hardware, software, or a combination of hardware and software.

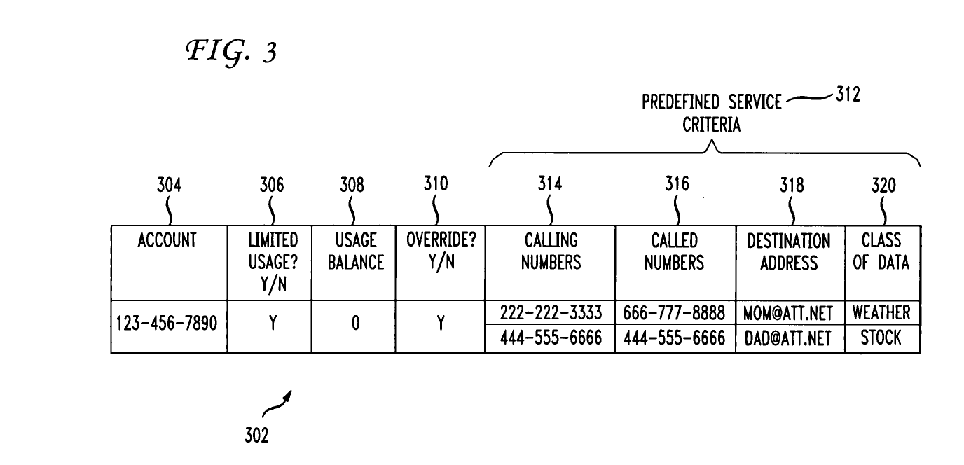

Returning now to step 202, the billing platform 106 determines whether the incoming call request is from a telephone associated with a limited use account. In one embodiment, the billing platform 106 access a subscriber record stored in DB 108. An exemplary subscriber record 302 is shown in FIG. 3. The record 302 contains an account field 304 which identifies the subscriber account associated with the record. In this example, the account identifier may be the telephone number of the wireless telephone associated with the account. Thus, in this example, field 304 contains 123-456-7890, which is the telephone number of telephone 116. Record 302 also contains the following additional fields. Field 306 which indicates whether this account is a limited usage account. Field 308 contains the balance remaining in a limited usage account. This balance may be in terms of monetary value, time, size (e.g., of data packets) or any other applicable unit. Filed 310 indicates whether this account has an override option. If this account has an override option, then the subscriber may define certain service criteria which, if satisfied, indicates that service should be provided, notwithstanding that the usage balance may be zero. For example, in the example used above, a parent may define usage criteria in terms of the dialed telephone number, such that if the wireless telephone 116 dials the telephone number of the parent's home landline telephone, the call will be allowed to go through even if the child's telephone has exceeded its usage limit.

The predefined service criteria 312, as shown in FIG. 3, contains 4 fields. A calling number field 314 which indicates that calls from certain originating telephone numbers will be allowed even if a usage limit has been reached or exceeded. A called number field 316 which indicates that calls to certain destination telephone numbers will be allowed even if a usage limit has been reached or exceeded. A destination address field 318 which may be used in connection with a messaging capability of a device which indicates that messages sent to certain destination addressed (e.g., internet protocol (IP) addresses) will be allowed even if a usage limit has been reached or exceeded. A class of data field 320 which may be used in connection with a data download capability of a device which indicates that certain types of data may be downloaded even if a usage limit has been reached or exceeded. These predefined service criteria will be described in further detail below. It is to be understood, however, that the particular predefined service criteria 312 shown in FIG. 3 is exemplary only, and that any type of predefined service criteria may be used in connection with the principles of the present invention.

Returning now to FIG. 2, in step 202 the billing platform 106 queries DB 108 to determine whether the account associated with wireless telephone 116 is a limited usage account. Filed 306 contains a “Y”, which indicates that this account is a limited usage account. Then, in step 204 it is determined that there is not a positive usage balance because field 308 contains 0. In step 206 it is determined that this account allows for a zero balance override as indicated in field 310. Next, in step 208, the predefined service criteria 312 in record 302 is checked to determine if this call should be connected notwithstanding that the usage limit has been reached. Since the called number (333-111-9999) does not match any of the numbers stored in field 316 (i.e., allowed called telephone numbers), this call will not be allowed and service will not be provided.

Alternatively, assume that wireless telephone 116 dialed the telephone number of the parent's landline home telephone 118 having a telephone number of 444-555-6666. Since this telephone number appears in field 316 as one of the allowed called telephone numbers, the call will be established. Thus, the call will be connected from MSC 104 to telephone 118 via line 110, IXC 112 and CO 114 in a well known manner.

Alternatively, the steps shown in FIG. 2 may be performed in connection with an incoming call to wireless telephone 116. Assume that a telephone (not shown) associated with telephone number 777-666-7890 dials the wireless telephone number of telephone 116. In this case, MSC 104 will receive a request to establish a connection with wireless telephone 116 (step 200). Processing will proceed as described above, and since the calling telephone number 777-666-7890 does not exist in field 314 (allowed calling telephone numbers), MSC 104 will not connect the call to wireless telephone 116. Alternatively, now assume that telephone 118 (i.e., the parent's landline home telephone) associated with telephone number 444-555-6666 dials the wireless telephone number of telephone 116. In this case, since calling telephone number 444-555-6666 does exist in field 314 (allowed calling telephone numbers), MSC 104 will connect the call to wireless telephone 116.

The above described examples described how both incoming and outgoing telephone calls may be processed in accordance with the steps of FIG. 2. The steps of FIG. 2 may also be applied to other types of services as well. For example, many wireless telephones have messaging capability (i.e., email or instant messaging) which allow the telephone to send a message to a device associated with a destination address. Assume for example that wireless telephone 116 has a zero usage balance (as shown in field 308) and attempts to send a message to a destination address of friend@network.com. Processing will proceed as described above, and in step 208 it will be determined whether the requested service (i.e., messaging) satisfies the predefined service criteria. Since friend@network.com is not one of the destination addressed stored in field 318, the system will not provide the messaging service. Alternatively, if the destination address of the message was dad@att.net, then the system will provide the messaging service for this message because dad@att.net is one of the destination addresses stored in field 318 and thus the requested service satisfied a predetermined service criteria.

In yet another example, the wireless telephone 116 may have a data download capability. For example, many wireless telephones have the capability of downloading data. For example, ring tones, games, stock quotes, weather information, etc., may be downloaded from a network to a wireless telephone. These various types of data may be assigned classes, and some classes may be defined in the predefined service criteria 312 in accordance with the principles of the present invention. For example, assume again that wireless telephone 116 has a zero usage balance (as shown in field 308) and user of telephone 116 attempts to download a new ring tone. Processing will proceed as described above, and in step 208 it will be determined whether the requested service (i.e., download) satisfies the predefined service criteria. Since “ring tone” is not one of the classes of data stored in field 320, the system will not provide the download service. Alternatively, if the wireless telephone attempted to download the weather forecast, then the system will provide the download service because “weather” is one of the classes of data stored in field 318 and thus the requested download service satisfies a predetermined service criteria.

In accordance with one embodiment of the invention, the subscriber associated with the telecommunication service account defines the predefined service criteria to be associated with the account. This allows for flexibility for each subscriber to configure their telecommunications service according to their own preferences. Subscribers may store the predefined service criteria 312 in their account record in various well known ways. For example, the telecommunication service provider may provide a call-in telephone number and voice response unit to allow the subscriber to access and modify their account record 302. Alternatively, the telecommunication service provider may provide a web interface to allow the subscriber to access and modify their account record 302.

While the above description relied mainly on a wireless telephone to describe a particular embodiment, the principles of the present invention may be applied to any type of telecommunication service and user devices. For example, and without limitation, such services and devices may be telephones (wireless and wired), mobile computing and data, messaging (wireless and wired), multimedia (e.g., audio and video), etc. Similarly, the invention can be used with any type of telecommunication technology including analog, digital, IP protocol, web access, IP telephony, ATM, frame relay, wireline, wireless, cellular, WIFI, etc. Likewise the invention can be used in conjunction with any type of subscription billing, including monthly post-paid billing, monthly prepaid billing, prepaid card, prepaid cellular, etc. Similarly, the service that is provided after the prepaid amount has been depleted can be billed for, and paid, in any way, including by credit vehicles, prepaid vehicles, or monthly subscription billing vehicles. The present invention is not limited to any one particular device, service or technology.

Further, while the above description provided several examples of predefined service criteria, the principles of the present invention may be applied utilizing any type of predefined service criteria. The criteria may encompass any conditions satisfactory to the subscriber. For example, and without limitation, although not described above, the predefined service criteria could have a time of day component, thus allowing/disallowing a zero balance override depending upon the time of day of the service request. The predefined service criteria could also have a location dependent component, for example being dependent upon a location of the calling/called party.

The foregoing Detailed Description is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the principles of the present invention and that various modifications may be implemented by those skilled in the art without departing from the scope and spirit of the invention. Those skilled in the art could implement various other feature combinations without departing from the scope and spirit of the invention.

1. A method for providing telecommunication services comprising the steps of:
receiving a request for telecommunication services associated with a subscriber device, said subscriber device associated with an account;
determining that a usage limit associated with said account has been exceeded; and
providing said telecommunication services if said request satisfies predefined service criteria.

2. The method of claim 1 wherein said request for telecommunication services comprises a request to establish an outgoing telephone call from said subscriber device to a called device associated with a called telephone number, and wherein said predefined service criteria requires that said called telephone number matches at least one predefined telephone number.

3. The method of claim 1 wherein said request for telecommunication services comprises a request to establish an incoming telephone call to said subscriber device from a calling device associated with a calling telephone number, and wherein said predefined service criteria requires that said calling telephone number matches at least one predefined telephone number.

4. The method of claim 1 wherein said request for telecommunication services comprises a request to send a data message from said subscriber device to a device associated with a destination address, and wherein said predefined service criteria requires that said destination address matches at least one predefined destination address.

5. The method of claim 1 wherein said request for telecommunication services comprises a request to download data to said subscriber device and wherein said predefined service criteria requires that said data matches at least one predefined class of data.

6. The method of claim 1 wherein said subscriber device is a wireless telephone.

7. The method of claim 1 wherein said usage limit is a monetary limit.

8. The method of claim 1 wherein said usage limit is a time limit.

9. The method of claim 1 wherein said account is a prepaid account.

10. The method of claim 1 wherein said predefined service criteria is defined by said subscriber.

11. Apparatus comprising:
means for receiving a request for telecommunication services associated with a subscriber device, said subscriber device associated with an account;
means for determining that a usage limit associated with said account has been exceeded; and
means for providing said telecommunication services if said request satisfies predefined service criteria.

12. The apparatus of claim 11 wherein said request for telecommunication services comprises a request to establish an outgoing telephone call from said subscriber device to a called device associated with a called telephone number, and wherein said predefined service criteria requires that said called telephone number matches at least one predefined telephone number.

13. The apparatus of claim 1 1 wherein said request for telecommunication services comprises a request to establish an incoming telephone call to said subscriber device from a calling device associated with a calling telephone number, and wherein said predefined service criteria requires that said calling telephone number matches at least one predefined telephone number.

14. The apparatus of claim 11 wherein said request for telecommunication services comprises a request to send a data message from said subscriber device to a device associated with a destination address, and wherein said predefined service criteria requires that said destination address matches at least one predefined destination address.

15. The apparatus of claim 11 wherein said request for telecommunication services comprises a request to download data to said subscriber device and wherein said predefined service criteria requires that said data matches at least one predefined class of data.

16. The apparatus of claim 11 wherein said subscriber device is a wireless telephone.

17. The apparatus of claim 11 wherein said usage limit is a monetary limit.

18. The apparatus of claim 11 wherein said usage limit is a time limit.

19. The apparatus of claim 11 wherein said account is a prepaid account.

20. The apparatus of claim 11 wherein said predefined service criteria is defined by said subscriber.

21. A method for providing wireless telecommunication services to a wireless telephone associated with a subscriber comprising the steps of:
accessing subscriber account data in response to a request to establish a call for said wireless telephone;
in response to a determination that a usage limit associated with said subscriber account has been exceeded, accessing predefined service criteria associated with said subscriber account;
determining whether said call satisfies said predefined service criteria; and
establishing said call only if said call satisfies said predefined service criteria.

22. The method of claim 21 wherein said call is an outgoing telephone call from said wireless telephone to a called telephone number, and wherein said predefined service criteria requires that said called telephone number matches at least one predefined telephone number.

23. The method of claim 21 wherein said call is an incoming telephone call from a calling telephone number to said wireless telephone, and wherein said predefined service criteria requires that said calling telephone number matches at least one predefined telephone number.

24. The method of claim 21 wherein said usage limit is a monetary limit.

25. The method of claim 21 wherein said usage limit is a time limit.

26. The method of claim 21 wherein said usage limit is associated with a prepaid account.

27. The method of claim 21 wherein said predefined service criteria is defined by said subscriber.

28. A computer readable medium storing a database, said database comprising a plurality of records, each of said records comprising:
an account identifier field for identifying a record associated with a subscriber;
a usage balance field indicating a usage balance remaining on said account; and
at least one predefined service criteria field defining conditions which, if met, allow a telecommunication service to be provided if said usage balance field indicates that a usage limit has been exceeded.

29. The computer readable medium of claim 28 wherein said at least one predefined service criteria field comprises at least one telephone number.

30. The computer readable medium of claim 28 wherein said at least one predefined service criteria field comprises at least one destination address.

31. The computer readable medium of claim 28 wherein said at least one predefined service criteria field comprises at least one class of data.
